(19) United States
(12) Patent Application Publication
(10) Pub. No.: US 2026/0284799 A1
(43) Pub. Date: Sep. 24, 2026

(54) METHOD FOR DETERMINING AN OPTIMIZED WELDING DIRECTION FOR A JOINTING PLANE; METHOD FOR DETERMINING AN OPTIMIZED JOINTING PLANE FOR THE JOINING OF TWO PARTS; AND METHOD FOR WELDING TWO PARTS

(71) Applicant: SAFRAN AIRCRAFT ENGINES, Paris (FR)

(72) Inventors: Virgile Pierre-Olivier MARGUIN, Moissy-Cramayel (FR); Abirami REMIGIUS RAJARANJITHAN, Moissy-Cramayel (FR)

(21) Appl. No.: 19/476,087

(22) PCT Filed: Apr. 17, 2024
(86) PCT No.: PCT/FR2024/050507

§ 371 Date: Oct. 16, 2025

(30) Foreign Application Priority Data
Apr. 20, 2023 (FR) 2304000

(51) Int. Cl. B23K 31/12; B23K 15/00; B23K 15/02; B23K 26/08; B23K 26/26

(52) U.S. Cl. CPC B23K 31/12; B23K 15/006; B23K 15/02; B23K 26/0869; B23K 26/26

(57) ABSTRACT

A method for determining an optimized welding direction for a jointing plane, a welding beam being intended to be moved in order to cover an edge of the jointing plane in the optimized welding direction while being maintained at a constant predefined angle with respect to the optimized welding direction, this method including for each of several potential welding directions passing through a centre of the jointing plane, a determination of a thickness of the jointing plane as a function of a position in the welding direction, this thickness being considered along a straight line forming the prede-fined angle with the welding direction and passing through the position concerned, and a calculation of a weldability score from the thickness as a function of the position in the welding direction, and a selection, as the optimized welding direction, of the potential welding direction having the best weldability score.

### TECHNICAL FIELD OF THE INVENTION

The present invention relates to a method for determining an optimized welding direction for a jointing plane, a method for determining an optimized jointing plane, and a corresponding computer program and system.

The invention is a technological solution dedicated to the industrialization of mechanically welded parts that are part of a mechanical system. It focuses on the concept of assembling metal parts using fusion welding methods.

### TECHNICAL BACKGROUND

To date, the mechanically welded parts are defined based on mechanical strength and dimensioning studies carried out by design departments, with significant modifications to certain interfaces for assembly, particularly the jointing planes. When a jointing plane profile is a candidate for welding, tests are carried out on representative specimens and similar or closely related production equipment. Based on the measurements taken during these tests, a welding range is drawn up to define the optimum parameters to be applied for the weld, and a partial or total redefinition of the jointing plane is carried out. Once a jointing plane has been selected, the main method of determining the welding direction to be used is trial and error on a test specimen, as well as feedback from the welding parts that are similar from a topological point of view.

The current method of defining the welding direction is limited by its manual and case-specific nature. The cost of testing representative welded specimens can be high and does not guarantee rapid convergence towards optimal jointing planes. In addition, the feedback can trap designers in historical profiles based on obsolete or unjustified specifications and technological expertise.

It may therefore be desirable to provide a method for determining an optimized welding direction in a jointing plane which avoids at least some of the aforementioned problems and constraints.

In addition, the Chinese patent application published under number CN 105 817 785 A describes a laser welding method for a workpiece with variable cross-section and thickness. In addition, the paper by J. Ogbemhe et al. entitled “Optimal trajectory scheme for robotic welding along complex joints using a hybrid multi-objective genetic algorithm” and published in IEEE ACCESS, describes how to find a trajectory for an articulated arm to make joints, so as to avoid collisions, speed and acceleration discontinuities, and jolts.

### SUMMARY OF THE INVENTION

A method is therefore proposed for determining an optimized welding direction for a jointing plane, with a welding beam configured to be moved to travel along an edge of the jointing plane in the optimized welding direction while being held at a constant predefined angle with respect to the optimized welding direction, characterized in that it comprises:
for each of several potential welding directions:
   determining a thickness of the jointing plane as a function of a position in the welding direction, this thickness being taken along a straight line forming the predefined angle with the welding direction and passing through the position concerned, and
   calculating a weldability score from the thickness as a function of position in the welding direction; and
selecting, as the optimized welding direction, the potential welding direction with the best weldability score.

The invention may also comprise one or more of the following optional characteristics, in any technically possible combination.

Optionally, the calculation of the weldability score includes a calculation of an assessment of a cumulative weld thickness, and the weldability score is calculated from this assessment of the cumulative weld thickness, so as to be better when the assessment of the cumulative weld thickness decreases.

Also optionally, the thickness being determined for several discrete positions in the welding direction, the assessment of the cumulative thickness to be welded is either the sum of polynomials of these discrete thicknesses, the polynomials being of degree greater than or equal to two, for example the sum of the squares of the discrete thicknesses, or the product of the squares of the discrete thicknesses, the weldability score being calculated from this sum of the squares.

Also optionally, the determination of the thickness as a function of the position in the welding direction comprises, for each of several discrete positions on the welding direction separated by a constant pitch, a counting of a number of points of a mesh superimposed on the jointing plane, the points counted being those strictly included in a strip inclined with respect to the welding direction, this strip being centered on the discrete position concerned and of a width such that the strips are contiguous, this number of points being taken as the thickness of the jointing plane at the discrete position concerned.

Optionally, the potential welding directions pass through a center of the jointing plane.

Also optionally, the center of the jointing plane is a center of gravity of points of a mesh superimposed on the jointing plane, these points being located in the jointing plane.

A method is also proposed for determining an optimized jointing plane between two parts to be welded, comprising:
receiving a definition of an initial jointing plane between the two parts;
starting from the initial jointing plane, an iteration of the following steps:
   determining an optimized welding direction in the jointing plane, in accordance with a method according to the invention, the weldability score of the found optimized welding direction being associated with the jointing plane, and
   as long as the weldability score does not satisfy an output condition of the iteration, modifying the jointing plane and continuing the iteration, otherwise the jointing plane with the best weldability score is taken as the optimised jointing plane.

Optionally, the definition of the initial jointing plane comprises positions of pilot points and a geometric shape consecutively connecting the pilot points to form a closed curve, and the modification of the jointing plane comprises a modification of the position of at least some of the pilot points.

Also proposed is a computer program that can be downloaded from a communications network and/or recorded on a computer-readable medium, characterized in that it comprises instructions for executing the steps of a method according to the invention, when said program is executed on a computer.

A method of welding two parts is also proposed, comprising:—determining an optimized welding direction for a jointing plane between the two parts in accordance with the invention, or determining an optimized jointing plane between the two parts in accordance with the invention; and—welding the two parts by moving the welding beam to travel along the edge of the jointing plane in the optimized welding direction while being held at the predefined constant angle to the optimized welding direction.

A data processing system configured to implement a method according to the invention is also proposed.

### BRIEF DESCRIPTION OF THE FIGURES

The invention will be better understood with the aid of the following description, given only by way of example and made with reference to the attached drawings wherein:

FIG. 1 is a three-dimensional view of the welding of two parts, illustrating in particular a jointing plane between these two parts,

FIG. 2 is a simplified view of a data processing system for welding optimization,

FIG. 3 is a block diagram of a method for determining an optimized welding direction for a jointing plane,

FIG. 4 is a block diagram of a method for determining an optimized jointing plane, using the method shown in FIG. 3,

FIG. 5 is a block diagram of a two-part welding method using the method shown in FIG. 4, and

FIG. 6 is a view of a jointing plane and a potential welding direction, illustrating an example of determining a thickness of the jointing plane along this welding direction.

### DETAILED DESCRIPTION OF THE INVENTION

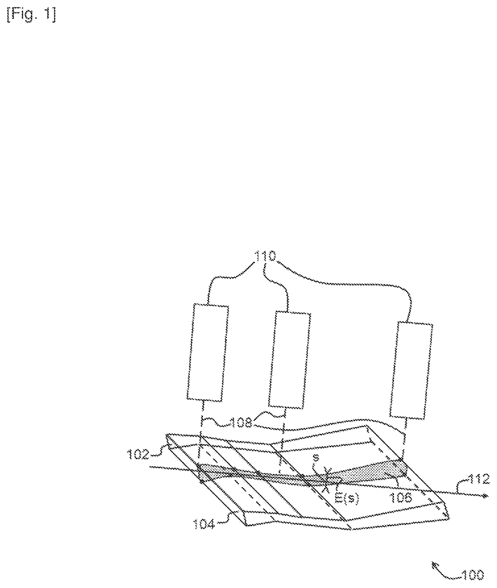

With reference to FIG. 1, an example of an assembly 100 obtained by welding will now be described.

The assembly 100 comprises two parts 102, 104 designed to be welded together. More specifically, each of the two parts 102, 104 has a flat welding face. These flat welding faces have geometries that mirror each other and are designed to be brought together and aligned with each other in order to be welded. These flat faces thus form a jointing plane 106 between the two parts 102, 104.

To carry out the welding, a welding beam 108 is emitted in the plane of the jointing plane 106 by a suitable welding device 110, to reach an edge of the jointing plane 106. This welding beam 108 is moved along the edge of the jointing plane 106 to fuse the two parts 102, 104 at the jointing plane 106. More precisely, the welding beam 108 is moved in a welding direction 112, i.e. parallel to this welding direction 112. The latter extends in the plane of the jointing plane 106 and passes, for example, through a center of the jointing plane 106, being maintained at a constant predefined angle relative to this welding direction 112 during its movement, for example perpendicular as in the example illustrated in FIG. 1.

In FIG. 1, the welding device 110 and the welding beam 108 are shown in three successive positions along the welding direction 112. Fusion welding includes, for example: TIG/MIG welding (Tungsten Inert Gas/Metal Inert Gas), laser welding, plasma welding, and electron beam welding (also referred to by the acronym FE).

It is possible to define, at each position s in the welding direction 112, a thickness E(s) of the jointing plane 106, this thickness E(s) being taken along the welding beam 108 passing through the position s concerned in the welding direction 112. In the example shown in FIG. 1, the thickness E(s) is taken along the perpendicular to the welding direction 112 passing through the position s concerned. This is the thickness through which the welding beam 108 must pass at each position s to weld the entire jointing plane 106.

The thickness curve E(s) represents the thickness history (or gradient) of the jointing plane 106 traversed by the welding beam 108 as it moves along the welding direction 112.

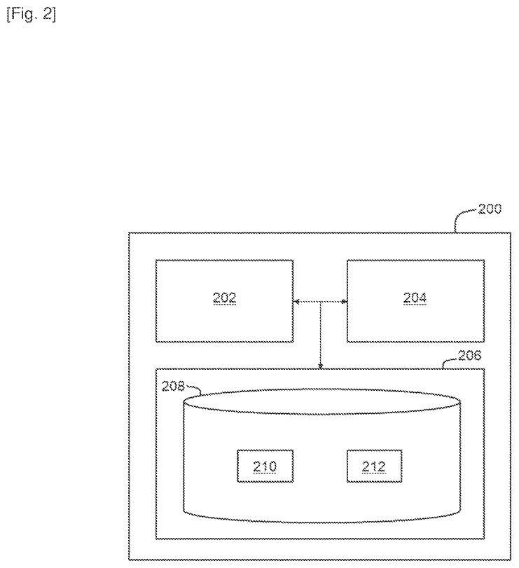

With reference to FIG. 2, an example of a data processing system 200 designed to optimize the jointing plane 106 and the welding direction 112 will now be described.

For example, the system 200 is a computer system comprising a data processing unit 202 (such as a microprocessor) and a main memory 204 (such as a RAM memory) accessible by the processing unit 202. The computer system 200 also comprises, for example, a network interface and/or a computer-readable medium, such as a local medium 206 (such as a local hard disk) or a remote medium (such as a remote hard disk accessible via the network interface through a communications network) or a removable medium (such as a USB key, Universal Serial Bus “, or a “Compact Disc” CD or a “Digital Versatile Disc” DVD) that can be read by an appropriate drive in the computer system 200 (such as a USB port or a CD and/or DVD drive). A computer program 208 containing instructions for the processing unit 202 is stored on the local medium 206 and/or can be downloaded via the network interface. This computer program 208 is, for example, intended to be loaded into the main memory 204 so that the processing unit 202 can execute its instructions. To make it easier to describe the computer program 208, the instructions will be described hereafter as organised into software modules. However, this presentation does not prejudge the form of the computer programme, which may be of any kind.

Alternatively, all or some of these modules could be implemented in the form of hardware modules, i.e. in the form of an electronic circuit, for example micro-wired, not involving a computer program.

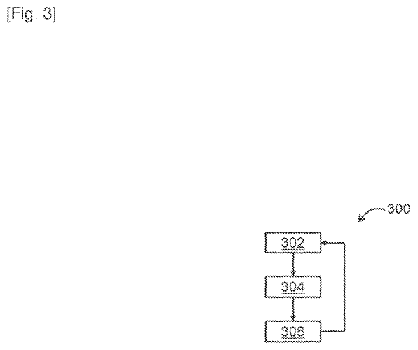

The computer program 208 therefore comprises a module 210 for determining an optimized welding direction in a jointing plane. The module 210 is in particular configured to implement a method 300 for determining a welding direction, such as that described in more detail below with reference to FIG. 3.

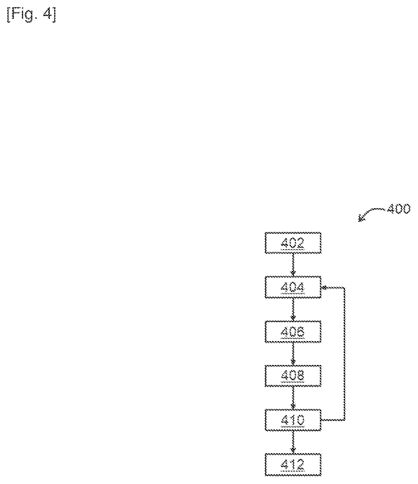

The computer program 208 also comprises a module 212 for determining an optimized jointing plane, using the module 210. The module 212 is in particular configured to implement a process 400 for determining an optimized jointing plane, such as that described in more detail below with reference to FIG. 4.

With reference to FIG. 3, an example of the method 300 for determining an optimized welding direction in a jointing plane 106 will now be described.

For each of several potential welding directions passing through a center of the jointing plane 106, the following steps 302, 304, 306 are carried out.

For example, the potential welding directions are angularly spaced by a fixed angular pitch, for example between 1° and 20°. Preferably, the potential welding directions cover at most 180° of the plane of the jointing plane.

For example, with a mesh superimposed on the jointing plane, the center of the jointing plane is a center of gravity for the mesh points located in the jointing plane. For example, the points of the mesh have the same weight when determining the center of gravity. To achieve this, the mesh should preferably consist of surface elements (flat) that are small enough to discretize the geometry of the jointing plane. By way of example, a maximum element surface area of one twenty-fifth of the surface area of the jointing plane is recommended. Preferably, the elements should be of the same geometric type (e.g., triangles or quadrilaterals).

In a step 302, the thickness E(s) of the jointing plane is determined as a function of the position s in the welding direction concerned. Thus, in the present invention, the thickness E(s) is a function giving the thickness of the jointing plane perpendicular to the welding direction concerned, i.e. the length of the portion of the perpendicular to the welding direction concerned extending over the jointing plane, as previously explained with reference to FIG. 1.

For example, the thickness E(s) of the jointing plane is determined for several discrete positions in the welding direction. The center of the jointing plane is, for example, one of these positions and the other positions are, for example, separated from each other by a fixed pitch. This pitch is preferably of the order of magnitude of the average distance between two neighbouring nodes in the mesh, i.e. between 0.5 and 1.5 times this distance. Preferably, the discrete positions extend on either side of the center of the jointing plane for at least 1.1 times the distance between the center and the node of the mesh in the jointing plane furthest from the center. This condition ensures that the discrete positions extend along the entire length of the jointing plane.

In this case, for each position s in the welding direction, for example, the number of mesh points strictly included in a strip inclined with respect to the welding direction 112 by the predefined angle of the welding beam 108, centered on the position s concerned and of a width such that the strips are contiguous, for example equal to the spacing between the positions when the predefined angle is a right angle (strip perpendicular to the welding direction), is counted. This number of points is taken as the thickness E(s) of the jointing plane at the position s concerned.

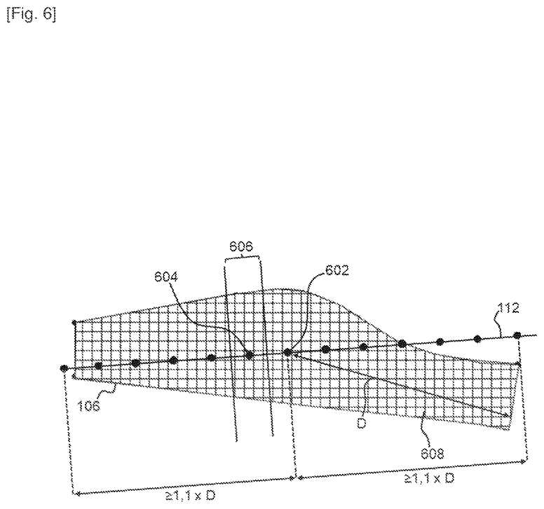

This example is illustrated in FIG. 6, where the references of FIG. 1 are repeated for the jointing plane and the welding direction, where the center of the jointing plane 106 bears the reference 602, where the current position on the welding direction 112 bears the reference 604, where the strip is referenced 606 and is perpendicular to the welding direction 112, as is the welding beam 108, where the mesh is referenced 608, and where the distance from the center 602 to the mesh node in the jointing plane furthest from the center 602 is referenced D. In the example shown in FIG. 6, the number of mesh points in the strip 606 is forty-five. So the thickness E (604) at the position 604 is forty-five.

Returning to FIG. 3, during a step 304, a weldability score S is calculated from the thickness E(s).

Preferably, the calculation of the weldability score S comprises a calculation of an assessment of a cumulative thickness to be welded and the weldability score S is calculated from this assessment of the cumulative thickness, to be better as the assessment of the cumulative thickness decreases. The weldability score S, for example, is taken to be equal to this assessment of the cumulative thickness. In calculating the cumulative thickness assessment, the thickness at each point contributes more significantly the greater the thickness at that point. The contributions (i.e. the thicknesses at the points concerned) are thus accumulated in the assessment, with each thickness weighted by itself. Thus, using the assessment of the cumulative thickness to be welded degrades the weldability score S (for example by making it high) for welding directions with high thicknesses to be traversed, either cumulatively or in peak form (i.e. when the thickness is high either punctually or for many consecutive points), and, conversely, improves the weldability score S (for example by making it low) for welding directions with low thicknesses to be traversed. In fact, the welding operation is easier when the cumulative thickness to be welded is low.

For example, when the thickness E(s) is determined for several discrete positions on the welding direction 112, the assessment of the cumulative thickness may be the sum of the squares of these discrete thicknesses, the weldability score S being calculated from this sum of squares, for example taken equal to this sum: S=ΣᵢE(Sᵢ)². More generally, the weldability score S can be calculated from a sum of polynomials of degree greater than or equal to 2, having thickness as a variable, for example taken equal to this sum: S=ΣᵢP(E(sᵢ)), with P the polynomial of degree greater than or equal to 2.

Alternatively, the weldability score S can be calculated from the product of the squares of the discrete thicknesses, for example taken to be equal to this product:

$$S = {\prod }_{i} {E ( {s}_{i} )}^{2} .$$

During a step 306, the potential welding direction with the best weldability score S is selected as the optimized welding direction. For example, the best weldability score S is the smallest, as in the case where the weldability score S is equal to the sum of the squares of the discrete thicknesses.

With reference to FIG. 4, an example of a method 400 for determining an optimized jointing plane will now be described.

During a step 402, operating data of the method is received, for example in a master control file.

The operating data includes a definition of an initial jointing plane. This definition comprises, for example, the positions of pilot points, as well as a geometric shape connecting consecutive pilot points to form a closed curve delimiting a closed surface. An example of a geometric shape is a series of straight line segments, each segment being delimited by two consecutive pilot points. Alternatively, the pilot points can be connected by splines, each spline being made up of one or more other points, known as intermediate points.

The operating data also comprises a definition of a mesh that allows the jointing plane to be discretized in the form of nodes and finite elements.

In general, two degrees of freedom are assigned to each pilot point and define the position of the pilot point in the plane of the jointing plane, the values of these degrees of freedom being initialized to initial values. The positions of the pilot points, for example, are marked in an orthogonal reference frame. The position of each pilot point can therefore be governed by a component Xp and a component Yp.

During a step 404, a mesh is superimposed on the initial jointing plane. This mesh allows for a regular discretization of the jointing plane, allowing the topological density in the plane of the jointing plane to be defined (i.e., for example, the number of nodes per unit area). For example, the mesh is made up of triangles and/or quadrilaterals. Preferably, the mesh should be sufficiently fine that the thickness of the jointing plane in any direction through the center of gravity of the mesh is traversed by at least four points of the mesh. For example, the number of elements in the mesh is increased until this condition is satisfied.

Starting from the initial jointing plane, the following steps 406, 408, 410 are iterated.

During a step 406, the center of the current jointing plane is determined. This is, for example, the center of gravity of the mesh points included in the current jointing plane, as explained above.

During a step 408, a welding direction optimized for the current jointing plane is determined using the method 300. The method 300 is preferably implemented each time with the same parameters, in particular: same mesh, same inter-position pitch on the welding direction, same formula for the weldability score, same angular pitch for the potential welding directions. Thus, it is possible to compare the results between the jointing planes. The weldability score associated with the optimized welding direction found is taken as the weldability score for the jointing plane concerned.

During a step 410, as long as the weldability score of the current jointing plane does not satisfy an output condition of the iteration, the current jointing plane is modified to obtain a new jointing plane and the iteration is continued by returning to the step 406, with this new jointing plane as the current jointing plane.

For example, the modification of the current jointing plane comprises a modification in the positions of at least part of the pilot points. In fact, when the position of one or more pilot points is modified, the shape of the current jointing plane is itself modified, thus generating a variant of the current jointing plane. This parameterization enables the jointing plane to be defined and modified from a digital point of view.

Preferably, there are areas of the jointing plane referred to as overall dimension, in which the pilot points cannot be located. These areas provide guidance for optimising the shape of the jointing plane and maintaining the desired overall shape of the assembly.

This modification is carried out, for example, by means of a parametric automated optimization algorithm, seeking to optimize the weldability score. The automated parametric optimisation algorithm implemented may, for example, be a differential algorithm based on an iterative strategy for constructing and enriching an interpolating response surface of the Radial Basis Function type. The enrichment criterion between each iteration may, for example, be the theoretical optimum identified by the differential evolution algorithm (known per se) on the basis of the response surface constructed at said iteration. One variant may be to use an interpolating response surface of the polynomial regression function type, with an iterative enrichment strategy using a local SQP (Sequential Quadratic Programming) algorithm.

If the weldability score of the current jointing plane satisfies the output condition of the iteration, the jointing plane with the best weldability score is taken as the optimized jointing plane.

For example, the output condition of the iteration may be that the weldability score S of the current jointing plane is below a predefined threshold. In this case, the last jointing plane, i.e. the one with a weldability score below the predefined threshold, is taken as the optimized jointing plane. Alternatively, the output condition of the iteration may be that the quality criterion R2 or Q2 of the RBF or polynomial regression response surface concerned reaches a significant threshold value, for example 0.9. In another variant, the output condition of the iteration is that a predefined number of iterations is reached, for example one hundred iterations.

In a step 412, the optimized jointing plane is provided (in particular the positions of its pilot points and an indication of the connection curve used (straight line segment, spline, etc.), together with the optimum welding direction found (for example, expressed as an angle in degrees relative to a predefined axis of the welding plane).

At least one of the following may also be provided:
for each welding direction of the optimized jointing plane, the list of thickness contributions used to calculate the weldability score S along the welding direction concerned (for example, in the case where the weldability score is the sum of the squares of the thicknesses, the list of the squares of the thicknesses is provided); and
the weldability criterion S for each of the welding directions evaluated for the optimized jointing plane, which allows to rank the different possible welding directions according to the weldability score S, and therefore to identify the optimum welding direction, as well as to quantify the gain in weldability score S.

The previous output data is supplied in a readable and editable results file (for example in .txt format) or not (specific formatting).

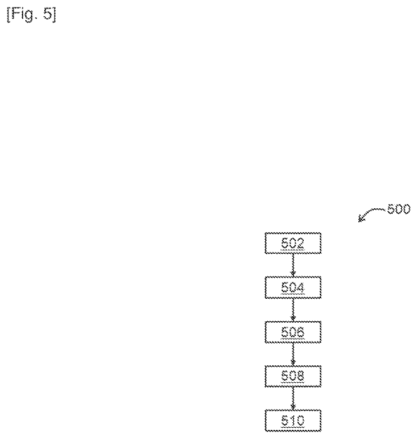

With reference to FIG. 5, an example of a method 500 for welding the two parts 102, 104 will now be described.

During a step 502, an optimized jointing plane is determined, along with its associated optimized welding direction, using the method 400.

During a step 504, the two parts 102, 104 are obtained, each with a flat welding face according to the optimized welding plane determined.

During a step 506, the flat welding faces of the two parts 102, 104 are brought together.

During a step 508, the two parts 102, 104 are welded together, by moving a welding beam in the determined optimized welding direction, so that this welding beam traverses an edge of the jointing plane.

It may happen that the parts 102, 104 are provided with reinforcements intended to facilitate welding, but which do not need to be retained for final assembly. Thus, during an optional step 510, a planing of the two parts 102, 104 can be planned around the weld to remove this reinforcement.

In conclusion, it should be noted that the invention is not limited to the embodiments described above. In fact, it will appear to the person skilled in the art that various modifications may be made to the above-described embodiments, in the light of the teaching just disclosed.

In particular, the operating data may include at least one of the following: the length of the welding directions, the coordinates of the center of the jointing plane used as the pivot point for the welding directions, the discretization pitch of the welding directions, the angular pitch between two welding directions, and the congestion areas of the welding plane.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. A method for determining an optimized welding direction for a jointing plane, a welding beam configured to be moved in order to travel along an edge of the jointing plane in the optimized welding direction while being held at a constant predefined angle with respect to the optimized welding direction, characterized in that it comprises:
for each of several potential welding directions:
determining a thickness of the jointing plane as a function of a position in the welding direction, this thickness being taken along a straight line forming the predefined angle with the welding direction and passing through the position concerned, and
calculating a weldability score from the thickness as a function of the position in the welding direction; and
selecting, as the optimized welding direction, the potential welding direction having the best weldability score.

2. The method according to claim 1, wherein the calculation of the weldability score includes a calculation of an assessment of a cumulative weld thickness, and the weldability score is calculated from this assessment of the cumulative weld thickness, so as to be better when the assessment of the cumulative weld thickness decreases.

3. The method according to claim 2, wherein, the thickness being determined for several discrete positions on the welding direction, the assessment of the cumulative thickness to be welded is either the sum of polynomials of these discrete thicknesses, the polynomials being of degree greater than or equal to two, for example the sum of the squares of the discrete thicknesses, or the product of the squares of the discrete thicknesses, the weldability score being calculated from this sum or this product.

4. The method according to claim 1, wherein the determination of the thickness as a function of the position on the welding direction comprises, for each of several discrete positions on the welding direction separated by a constant pitch, a counting of a number of points of a mesh superimposed on the jointing plane, the points counted being those strictly included in a strip inclined with respect to the welding direction by the predefined angle, this strip being centered on the discrete position concerned and of a width such that the strips are contiguous, this number of points being taken as the thickness of the jointing plane at the discrete position concerned.

5. The method according to claim 1, wherein the potential welding directions pass through a centre of the jointing plane.

6. The method according to claim 5, wherein the center of the jointing plane is a center of gravity of points of a mesh superimposed on the jointing plane, these points being located in the jointing plane.

7. The method of determining an optimized jointing plane between two parts to be welded, comprising:
receiving a definition of an initial jointing plane between the two parts;
starting from the initial jointing plane, an iteration of the following steps:
determining an optimized welding direction in the jointing plane, in accordance with a method according to claim 1, the weldability score of the found optimized welding direction being associated with the jointing plane, and
as long as the weldability score does not satisfy an output condition of the iteration, modifying the jointing plane and continuing the iteration, otherwise the jointing plane with the best weldability score is taken as the optimised jointing plane.

8. The method according to claim 7, wherein defining the initial jointing plane comprises positions of pilot points and a geometric shape consecutively connecting the pilot points to form a closed curve, and wherein modifying the jointing plane comprises modifying the position of at least some of the pilot points.

9. A computer program that can be downloaded from a communication network and/or recorded on a computer-readable medium, characterized in that it comprises instructions for executing the steps of a method according to claim 1, when said program is executed on a computer.

10. A method for welding two workpieces, comprising:
determining an optimized welding direction for a jointing plane between the two parts according to claim 1, or determining an optimized jointing plane between the two parts; wherein the determining the optimized jointing plane between the two parts to be welded, comprises:
receiving a definition of an initial jointing plane between the two parts;
starting from the initial jointing plane, an iteration of the following steps:
determining an optimized welding direction in the jointing plane, in accordance with a method according to claim 1, the weldability score of the found optimized welding direction being associated with the jointing plane, and
as long as the weldability score does not satisfy an output condition of the iteration, modifying the jointing plane and continuing the iteration, otherwise the jointing plane with the best weldability score is taken as the optimised jointing plane.
and
welding the two parts by moving the welding beam to travel along the edge of the jointing plane in the optimized welding direction, while being held at a predefined constant angle with respect to the optimized welding direction.

11. A data processing system configured to implement a method according to claim 1.
